(19) United States
(12) Patent Application Publication
(10) Pub. No.: US 2016/0200889 A1
(43) Pub. Date: Jul. 14, 2016

(54) VACUUM ASSISTED PROCESS TO MAKE CLOSED CELL RIGID POLYURETHANE FOAMS USING MIXED BLOWING AGENTS

(71) Applicant: DOW GLOBAL TECHNOLOGIES LLC, Midland, MI (US)

(72) Inventors: Vanni Parenti, Campagnola (IT); Rossella Riccio, Correggio (IT); Hans Kramer, Kempraten-Jona (CH)

(21) Appl. No.: 14/911,689

(22) PCT Filed: Sep. 18, 2014
(86) PCT No.: PCT/US14/56375

§ 371 Date: Feb. 11, 2016

(30) Foreign Application Priority Data
Sep. 19, 2013 (IT) MI2013A001547

(51) Int. Cl. C08J 9/14; C08J 9/12; C08G 18/32; C08G 18/34; C08G 18/08; C08G 18/76

(52) U.S. Cl. CPC C08J 9/146; C08G 18/14; C08G 18/7671; C08G 18/3206; C08G 18/34; C08G 18/3275; C08J 9/127; C08J 9/125; C08J 9/141; C08J 9/149; C08G 2101/0025

(57) ABSTRACT

Rigid polyurethane foam is made in a vacuum assisted process using a blowing agent mixture that includes water and hydrofluoroolefin and/or hydrofluorochloroolefin. In preferred embodiments, the blowing agent mixture further includes a hydro carbon such as cyclopentane.

This invention relates to formulations and processes to make closed cell rigid polyurethane foams. More particularly, it relates to processes to make fast-reacting, low density rigid polyurethane foams that may be used for, in particular, appliance insulation.

One of the most commercially important applications for rigid polyurethane foams is in the appliance industry. In this application the foams supply insulation from heat and/or cold, and may also serve to increase structural integrity and/or strength of the appliance. In particular applications such as refrigerators, freezers, hot water storage tanks, and pipe-in-pipe, a rigid polyurethane foam formulation is injected into a cavity wherein the formulation first expands to fill the cavity and then completes reacting to form the final rigid polyurethane foam.

There are many demands on the process and the foam formulation. The foam formulation must expand to fill the cavity as uniformly as possible, so mechanical and thermal properties remain consistent throughout the cavity. The formulation must expand to a low density for reasons of cost, weight and thermal conductivity. It needs to cure rapidly to minimize cycle time and correspondingly maximize equipment usage rates. Because the foam contributes to the mechanical strength of the product, its mechanical properties are important. In addition to this, the foam needs to have low thermal conductivity.

WO 2010/046361 describes a vacuum-assisted process for producing polyurethane foam-filled cavities. In that process, the foam formulation is injected into the cavity under a partial vacuum. The vacuum is maintained until the foam formulation expands and cures. The main advantage of the process described in WO 2010/046361 is that the cured foam is typically highly uniform in its properties. In addition, the process allows highly reactive foam formulations to be used. This allows for fast cures and short demold times.

The blowing agents in the foam formulations form gas mixtures that remain in the cells of the cured foam. The composition of the gas mixture plays an important role in the thermal characteristics of the foam. Generally speaking, one wants to use blowing agents that have as low a thermal conductivity as possible. For this reason, polyurethane foams have historically been made using chlorofluorocarbon blowing agents. However, many of these have been regulated out of use due to their ozone depletion potential (ODP) and/or their global warming potential (GWP), or else are facing regulatory pressure. There is a strong incentive to use blowing agents that have zero ODP and a small GWP.

However, as is well known, the selection of a suitable blowing agent is much more complex than simply screening compounds for low thermal conductivity, low ODP and low GWP. These characteristics by themselves are not sufficient to predict how a candidate blowing agent will perform in a specific application from a processing standpoint or a performance standpoint.

Foam processing is very important from a manufacturing standpoint, as the foam formulation containing the blowing agent must be easy to handle and process, must cure rapidly, and upon curing must form a foam that has needed mechanical attributes as well as the necessary thermal characteristics. In appliance foam applications, the foam formulation must be able to expand uniformly and flow around corners and around objects that penetrate into the cavity to form a low density foam. This quality can be greatly impacted by the selection of blowing agent. The blowing agent in some cases also can have a plasticizing effect on the cured polymer, which can affect mechanical properties in a significant way. In addition, the thermal characteristics of the foam depend not only on the thermal conductivity of the blowing agent itself, but on the cell structure (for example, cell size and proportion of closed cells) and the ability of the foam to retain the blowing agent over time. The use temperature is still another important factor, as some blowing agents can provide adequate performance at some use temperatures, but not others. All of these considerations make it very difficult to predict which blowing agent candidates can be used with success.

Yet another important attribute of polyurethane foam formulations for appliance applications is a property referred to as “flow index”, or simply “flow”. A foam formulation will expand to a certain density (known as the ‘free rise density’) is permitted to expand against minimal constraints. When the formulation must fill a refrigerator or freezer cabinet, its expansion is constrained in several ways. The formulation must expand within a narrow cavity, often in mainly a vertical (rather than horizontal) direction. As a result, the formulation must expand against a significant amount of its own weight. The formulation also must flow around corners and into all portions of the wall cavities. Because of these constraints, a greater amount of the foam formulation is needed to fill the cavity than would be predicted from the free rise density. The amount of foam formulation needed to minimally fill the cavity can be expressed as a minimum fill density (the weight of the minimum amount of foam formulation needed to fill the cavity divided by the cavity volume). The ratio of minimum fill density to free rise density is the flow index. The flow index is ideally 1.0, but in commercial settings this ideal value is never attained. More typical values for flow index are on the order of 1.25 to 1.5. Reducing the flow index decreases the amount of material needed to fill the cavity, which decreases costs and for that reason is highly desirable, although not at the expense of k-factor.

WO 2010/046361 describes various blowing agents and combinations of blowing agents. Among these are several types of physical (endothermic) blowing agents and combinations of these with water (which in a polyurethane system is a chemical blowing agent that reacts with isocyanate groups to liberate carbon dioxide). WO 2010/046361 expresses a preference for a mixture of water and cyclopentane or cyclohexane, or a mixture of water, cyclopentane or cyclohexane and another at least one additional physical blowing agent from the group consisting of n-butane, isobutane, n- and isopentane, technical-grade pentane mixtures, cyclobutane, methyl butyl ether, diethyl ether, furan, trifluoromethane, difluoromethane, difluoroethane, tetrafluoroethane, and heptafluoropropane.

It is desirable to replace the blowing agent in the process described in WO 2010/046361 with a blowing agent that offers a lower GWP, while maintaining a zero ODP and obtaining equivalent or even superior processing performance and thermal insulation performance.

A new class of low-boiling fluorochemicals is under development. This class includes fluorinated or chlorinated and fluorinated olefins, and are known as HFOs (hydrofluoroolefins) or HCFOs (hydrochlorofluoroolefins). The HFOs and HCFOs have zero or close to zero ODPs and in many cases have very low GWPs, which makes them attractive from an environmental standpoint. Compounds of these types are described, for example, in US 2004-0089839, US 2004-0119047, US 2006-0243944, US 2007-0100010 and U.S. Pat. No. 6,858,571. Some of these references contain a mention the possible use of certain of these materials as blowing agents for making foamed polymers. US 2010/0112328 and US 2004/01190947 describe the use of some of these as blowing agents for making extruded polystyrene or polyethylene foam. U.S. Pat. No. 4,085,073 mentions 3,3,3-trifluoropropene as a diluent in an extruded thermoplastic polymer foam composition that is blown with conventional hydrofluorocarbon blowing agents.

Some references describe the use of HFOs or HCFOs as a blowing agent for manufacturing polyurethane foams. US 2007/0100010 mentions a large number of HFOs and HFCOs as candidates for making polyurethane foam, but demonstrates the use of only two specific compounds, 1,1,1,4,4,5,5,5-octafluoro-2-pentene (HFC-1438mzz) and Z-1,1,1,4,4,4-hexafluoro-2-butene (HFC-1336mzz, Z-isomer). No use of these blowing agents to make appliance foams is shown. The foam blown with FC-1438mzz had a somewhat high reported K-factor of 0.2044 BTU-in/hr-ft² (29.5 mW/m·K) when measured at a mean temperature of 24° C. (75.2° F.). K-factor performance at lower temperatures typical of refrigeration conditions are not provided. US 2007/0100010 does not report the K-factor performance of the HFC-1336mzz-blown foam.

US 2012/0121805 describes polyurethane foams blown with certain hydrofluorocarbons including HFOs or HCFOs such as 1,1,1,4,4,4-hexafluoro-2-butene, Z isomer (HFO 1336mzz, also known as FEA-1100 from Du Pont), trans-1,3,3,3-tetrafluoropropene (HFO-1234ze, also known as HBA-1 from Honeywell), 1-chloro-3,3,3-trifluoropropene (HFO-1233zd, also known as HBA-2 from Honeywell), and proprietary materials from Arkema known as AFA-L1 and AFA-L2. The application in this case is pour-in-place thermal insulation for frame building construction. US 2012/0121805 also mentions that miscible mixtures of these with another physical blowing agent can be used. In an example, HFO-1336mzz produced an open-cell foam having rather poor thermal insulation characteristics.

U.S. Pat. No. 8,541,478 includes examples of rigid polyurethane foam blown with a mixture of water and HCFO 1233zd. The foams are cell to contain mainly closed cells, but no thermal conductivity or flow data is reported.

Also, U.S. Pat. No. 5,205,956 describes rigid polyurethane foam blown using compounds having the structure H₃C═CH—CₙF_{2 n+1.} By itself, these blowing agents did not produce foam having low thermal conductivities. Thermal conductivities below about 19 mW/m-K could be obtained only by adding another fluorinated blowing agent.

Loh et al., in “Performance Update on Formacel® 1100 (FEA-1100), a Zero ODP and Low GWP Foam Expansion Agent”, http://www2.dupont.com/Formacel/en_US/assets/downloads/ 20120508_FEA-1100_Performance_Update_paper.pdf, describe polyurethane foams made using mixtures of water, cyclopentane and HFO 1336 mzz.

This invention is in one aspect a process for preparing a cavity-filling closed cell rigid polyurethane foam, comprising (a) preparing a reactive foam-forming system comprising as components at least one organic polyisocyanate; a polyol mixture having an average functionality of at least 3.0 hydroxyl groups per molecule and an average hydroxyl equivalent weight of 75 to 250; a blowing agent mixture containing water, at least one HFO or HCFO and optionally at least one hydrocarbon, the blowing agent mixture containing 5 to 60 mole percent water and at least 2 mole percent of the HFO or HCFO; (b) injecting the reactive foam-forming system into a cavity and at least partially expanding the foam-forming system under a reduced atmospheric pressure and (c) maintaining the reduced atmospheric pressure at least until a gel forms, and further curing the reactive foam-forming system to produce a closed cell rigid polyurethane foam having a density of less than about 40 kg/m³ and a thermal conductivity of less than 19 mW/m·K at 10° C. average plate temperature, as measured according to ISO 12939/DIN 52612.

This invention is also process for preparing a cavity-filling closed cell rigid polyurethane foam, comprising (a) preparing a reactive foam-forming system comprising as components at least one organic polyisocyanate; a polyol mixture having an average functionality of at least 3.0 hydroxyl groups per molecule and an average hydroxyl equivalent weight of 75 to 250; a blowing agent mixture containing water, a hydrocarbon blowing agent and at least one HFO or HCFO, the blowing agent mixture containing 5 to 60 mole percent water and the mole ratio of the hydrocarbon to the HFO or HCFO being 5:95 to 95:5; (b) injecting the reactive foam-forming system into a cavity and at least partially expanding the foam-forming system under a reduced atmospheric pressure and (c) maintaining the reduced atmospheric pressure at least until a gel forms and further curing the reactive foam-forming system to produce a closed cell rigid polyurethane foam having a density of less than about 40 kg/m³ and a thermal conductivity of less than 19 mW/m·K at 10° C. average plate temperature, according to ISO 12939/DIN 52612.

The process of the invention produces rigid foams having both low k-factors and low flow indices.

Suitable organic polyisocyanates may be aliphatic, cycloaliphatic, araliphatic or aromatic polyisocyanates, or combinations thereof. Such may include, for example, alkylene diisocyanates, particularly those having from 4 to 12 carbon atoms in the alkylene moiety, such as 1,12-dodecane diisocyanate, 2-ethyltetramethylene 1,4-diisocyanate, 2-methyl-pentamethylene 1,5-diisocyanate, 2-ethyl-2-butylpentamethylene 1,5-diisocyanate, tetramethylene 1,4-diisocyanate and preferably hexamethylene 1,6-diisocyanate; cycloaliphatic diisocyanates such as cyclohexane 1,3-and 1,4-diisocyanate and any desired mixture of these isomers, 1-isocyanato-3,3,5-trimethyl-5-isocyanato-methylcyclohexane (isophorone diisocyanate), 2,4- and 2,6-hexahydrotoluene diisocyanate and the corresponding isomer mixtures, 4,4′-, 2,2′- and 2,4′-dicyclohexylmethane diisocyanate and the corresponding isomer mixtures, araliphatic diisocyanates such as 1,4-xylylene diisocyanate and xylylene diisocyanate isomer mixtures, and preferably aromatic diisocyanates and polyisocyanates, such as 2,4- and 2,6-toluene diisocyanate and the corresponding isomer mixtures, 4,4′-, 2,4′- and 2,2′-diphenylmethane diisocyanate and the corresponding isomer mixtures, mixtures of 4,4′- and 2,4′-diphenylmethane diisocyanates, polyphenyl-polymethylene polyisocyanates, mixtures of 4,4′-, 2,4′- and 2,2′-diphenylmethane diisocyanates and polyphenylpolymethylene polyisocyanates (crude MDI), and mixtures of crude MDI and toluene diisocyanates. The organic polyisocyanates may be employed individually or in the form of combinations thereof.

Modified polyisocyanates, i.e., products which are obtained by chemical reaction of organic diisocyanates and/or polyisocyanates, may also be used. Specific examples are ester-, urea-, biuret-, allophanate-, uretoneimine-, carbodiimide-, isocyanurate-, uretdione- and/or urethane-containing diisocyanates and/or polyisocyanates, that contain from 33.6 to 15 percent by weight, preferably from 31 to 21 percent by weight, of isocyanate groups, based on the total weight of the modified polyisocyanate.

The second component of the reactive system is a polyol mixture. The polyol mixture contains two or more polyol compounds, i.e., compounds having at least 2 hydroxyl groups. The polyol mixture has an average functionality of at least 3.0 hydroxyl groups per molecule and an average hydroxyl equivalent weight of 75 to 250. Water is not considered as part of the polyol mixture for purposes of calculating average functionality and hydroxyl equivalent weight.

The individual polyols may be, for example, polythio-ether-polyols, polyester-amides, hydroxyl-containing polyacetals, hydroxyl-containing aliphatic polycarbonates, and preferably polyester-polyols, hybrid polyether-polyester polyols and polyether-polyols. The individual polyols may have hydroxyl equivalent weights from 30 to 6000, and hydroxyl functionalities from 2 to 8 or more, provided that the polyol mixture has an average equivalent weight and average functionality as indicated above.

The polyol mixture preferably has a viscosity at 25° C. of at least 2,500 centipoises (cP) as measured according to ASTM D455. Preferred minimum viscosities are at least 3,500, at least 5,000 or at least 6,000 cP. A preferred maximum viscosity is 20,000 cP and a more preferred maximum viscosity is 15,000 cP.

The polyol mixture preferably contains at least about 10 percent by weight of one or more amine-initiated polyether polyols. This amine-initiated polyol may have a hydroxyl functionality from 2 to 8, preferably 3 to 8, and a hydroxyl equivalent weight of 60 to 280. The amine-initiated polyol is formed by adding one or more alkylene oxides onto an initiator compound containing two or more amine nitrogen atoms, or, equivalently, onto an aminoalcohol. The initiator compound can be aromatic, aliphatic or alicyclic (or some combination of these). Examples of amine initiators include ethylenediamine, diethylenetriamine, triethylenetetramine, 1,3-propylene diamine, 1,3- and 1,4-butylene diamine, 1,2-, 1,3-, 1,4-, 1,5- and 1,6-hexamethylenediamine, aniline, any of the various phenylenediamine isomers, any of the various isomers of cyclohexanediamine, 2,3-, 2,4-, 3,4- and 2,6-toluenediamine and 4,4′-, 2,4′- and 2,2′-diaminodiphenylmethane. Examples of aminoalcohols include ethanolamine, N-methyl- and N-ethylethanolamine, dialkanolamines such as diethanolamine, N-methyl- and N-ethyldiethanolamine, and trialkanolamines such as triethanolamine or triisopropanolamine. The alkylene oxide may be, for example, ethylene oxide, 1,2-propylene oxide, 1,3-propylene oxide, 1,2-butylene oxide, 2,3-butylene oxide, tetramethylene glycol, styrene oxide and the like, with ethylene oxide and 1,2-propylene oxide (or combinations thereof) being preferred. If a combination of ethylene oxide and 1,2-propylene oxide, they can be added sequentially in either order, or as a mixture.

The polyol mixture may contain one or more other polyether polyols that are based on non-amine initiators. The initiators in this case are suitable compounds containing two or more hydroxyl groups. The initiator compounds may be aromatic or aliphatic. Aromatic initiator compounds include various biphenol or polyphenol compounds such as resorcinol, various dihydroxydiphenylalkanes, novolac resins, and the like. Aliphatic initiators include acyclic and alicyclic compounds such as ethylene glycol, diethylene glycol, triethylene glycol, 1,2-propane diol, dipropylene glycol, tripropylene glycol, glycerin, trimethylol propane, trimethylol ethane, pentaerythritol, erythritol, sorbitol, sucrose, mannitol and the like. Polyether polyols are prepared by adding an alkylene oxide as described above to the initiator. These polyether polyols may have hydroxyl equivalent weights and hydroxyl functionalities as described with respect to the amine-initiated polyols.

The polyol mixture may contain one or more polyester polyols or hybrid polyether-polyester polyols. The polyester polyols or hybrid polyether-polyester polyols preferably have a functionality of at least 2, preferably 2 to 8, hydroxyl groups per molecule and a hydroxyl equivalent weight of 90 to 375, preferably 140 to 280. Suitable polyester polyols may be prepared from, for example, organic dicarboxylic acids having from about 2 to about 12 carbon atoms, preferably aromatic dicarboxylic acids having from 8 to 12 carbon atoms, and polyhydric alcohols, preferably diols having from 2 to 12 carbon atoms, preferably from 2 to 6 carbon atoms. Examples of suitable dicarboxylic acids are succinic acid, glutaric acid, adipic acid, suberic acid, azelaic acid, sebacic acid, decanedicarboxylic acid, maleic acid, fumaric acid, and preferably phthalic acid, isophthalic acid, terephthalic acid and the isomeric naphthalene-dicarboxylic acids. The dicarboxylic acids may be used either individually or mixed with one another. The free dicarboxylic acids may also be replaced by the corresponding dicarboxylic acid derivatives, for example, dicarboxylic esters of alcohols having 1 to 4 carbon atoms or dicarboxylic anhydrides. A preferred polyester polyol is made using a dicarboxylic acid mixture comprising succinic acid, glutaric acid and adipic acid in ratios of, for example, from 20 to 35:35 to 50:20 to 32 parts by weight. Another preferred polyester polyol is made using a mixture of phthalic acid and/or phthalic anhydride and adipic acid, a mixture of phthalic acid or phthalic anhydride, isophthalic acid and adipic acid, a mixture of succinic acid, glutaric acid and adipic acid, a mixture of terephthalic acid and adipic acid or a mixture of succinic acid, glutaric acid and adipic acid. Examples of dihydric and polyhydric alcohols, in particular diols, are ethanediol, diethylene glycol, 1,2- and 1,3-propanediol, dipropylene glycol, 1,4-butanediol, 1,5-pentanediol, 1,6-hexanediol, 1,10-decanediol, glycerol, trimethylolpropane. Preference is given to ethanediol, diethylene glycol, 1,4-butanediol, 1,5-pentanediol, 1,6-hexanediol or mixtures of at least two of said diols, in particular mixtures of 1,4-butanediol, 1,5-pentanediol and 1,6-hexanediol. Furthermore, polyester-polyols made from lactones, e.g., E-caprolactone or hydroxycarboxylic acids, e.g., ω-hydroxycaproic acid and hydrobenzoic acid, may also be employed.

Suitable hybrid polyether-polyester polyols are described, for example, in WO 2011/137011.

Examples of suitable hydroxyl-containing polyacetals are compounds prepared from glycols such as diethylene glycol, triethylene glycol, 4,4′-dihydroxyethoxydiphenyldimethylmethane and hexanediol, and formaldehyde. Suitable polyacetals can also be prepared by polymerizing cyclic acetals.

Suitable hydroxyl-containing polycarbonates include those prepared, for example, by reacting diols such as 1,3-propanediol, 1,4-butanediol and/or 1,6-hexanediol, diethylene glycol, triethylene glycol or tetraethylene glycol, with diaryl carbonates, such as diphenyl carbonate, or phosgene.

The polyester-amides include, for example, the predominantly linear condensates obtained from polybasic, saturated and/or unsaturated carboxylic acids or anhydrides thereof and polyhydric, saturated and/or unsaturated amino alcohols, or mixtures of polyhydric alcohols and amino alcohols and/or polyamines.

Other suitable compounds containing at least two reactive hydrogen atoms include phenolic and halogenated phenolic polyols such as resol-polyols containing benzyl ether groups. Resol-polyols of this type can be prepared, for example, from phenol, formaldehyde (expediently paraformaldehyde) and polyhydric aliphatic alcohols. Such are described in, for example, EP-A-0 116 308 and EP-A-0 116 310.

The polyol mixture may further contain one or more polyols having an equivalent weight of 30 to 59, including, for example, one or more of ethylene glycol, diethylene glycol, triethylene glycol, 1,2-propane diol, 1,3-propanediol, dipropylene glycol, tripropylene glycol, glycerin, trimethylol propane, trimethylol ethane, neopentyl glycol, 1,6-hexanediol, 1,4-cyclohexanedimethanol, 1,2,6-hexanetriol, triethanolamine, pentaerythritol, erythritol, sorbitol, sucrose, mannitol, N,N,N′,N′-tetrakis(2-hydroxypropyl)-ethylenediamine, diethyltoluenediamine, dimethylthiotoluenediamine and combinations thereof.

In certain preferred embodiments, the polyol system may include a mixture including (a) at least one amine-initiated polyether polyol and (b) at least one polyester polyol or hybrid polyether-polyester polyol, optionally further containing (c) at least one non-amine-initiated polyether polyol. In such a mixture, component (c), when present, preferably includes at least one polyether polyol having a hydroxyl functionality of 4 to 8, preferably 6 to 8, and a hydroxyl equivalent weight of 30 to 125. Such a mixture may also include glycerin or other polyol having a hydroxyl equivalent weight of 30 to 59. The amine-initiated polyether polyol may constitute 10 to 70%, preferably 25 to 60%, by weight of such a polyol system.

Another preferred polyol system includes (a) at least one amine-initiated polyether polyol and (b) at least one polyester polyol or hybrid polyether polyester polyol, (c) at least one non-amine-initiated polyether polyol having a hydroxyl functionality of 4 to 8, preferably 6 to 8, and a hydroxyl equivalent weight of 60 to 125 and (d) at least one non-amine-initiated polyether polyol having a hydroxyl equivalent weight of at least 300. Such a mixture may also include (e) glycerin or other polyol having a hydroxyl equivalent weight of 30 to 59. The amine-initiated polyether polyol may constitute 10 to 70%, preferably 25 to 60%, by weight of such a polyol system.

The blowing agent is a mixture of water and an HFO or HCFO. A preferred blowing agent is a mixture that includes water, certain hydrocarbon blowing agents, and an HFO or HCFO. The blowing agent mixture contains 5 to 60 mole percent water, preferably 15 to 60 mole percent water, more preferably 20 to 50 mole percent water and in certain embodiments 20 to 33 mole-percent water or 22 to 30 mole percent water.

In some embodiments, the HFO or HCFO (or mixture of two or more thereof) constitutes the remainder of the blowing agent, i.e., 40 to 95 mole percent, preferably 40 to 85 mole-percent, more preferably 50 to 80 mole percent and in some embodiments 67 to 80 mole percent or even 70 to 78 mole percent of the blowing agent mixture.

Preferred blowing agent mixtures include water in the amounts stated above, and a mixture of one or more hydrocarbons with one or more HFOs and/or HCFOs. The mole ratio of the hydrocarbons and the HFO(s) and/or HCFO(s) may be 5:95 to 95:5, 15:85 to 50:50, 25:75 to 50:50 or 30:70 to 50:50. In some embodiments, this ratio may be 15:85 to 30:70. The blowing agent preferably contains no more than 5 mole percent, more preferably no more than 2 mole-percent of other blowing agents (if any at all).

The hydrocarbon blowing agent may have a boiling temperature of, for example, −20 to 60° C., preferably 20 to 60° C. and more 30 to 60° C. Butane and pentane isomers are preferred, including isobutane, n-butane, cyclopentane, n-pentane and isopentane or mixtures of any two or more of these. Cyclopentane and mixtures of 50-99% cyclopentane and 1 to 50% isopentane are especially preferred.

The HFO or HCFO may include any of those described, for example, in US 2007/0100010. Among the useful HFOs and HCFOs are those having 3 or 4 carbon atoms and a halogen atom bonded to the 1-carbon atom. HFO and HCFO compounds have boiling temperatures from −30° C. to 60° C. are preferred. HFO and HCFO compounds having an ODP of zero and a GWP of less than 20, preferably less than 10 are especially preferred. The invention has particular advantages when the HFO compound has a boiling temperature of at least 20° C. Specific examples of HFO and HCFO compounds includes HFO 1234ze (1,3,3,3-tetrafluoropropene), HCFO 1233zd (1-chloro-3,3,3-trifluoropropene), HFO 1336 mzz (1,1,1,4,4,4-hexafluorobut-2-ene) and a product marketed by Arkema as AFA-L1. HFO 1336mzz is an especially preferred HFO blowing agent, as its lower temperature performance at higher molar concentrations is improved significantly with this invention.

In order to produce the rigid polyurethane foams of the invention, the blowing agent(s), in combination with water, is/are introduced via known methods into at least one of the formulation components prior to the final foam-forming reaction. Introduction into such component may be carried out under pressure if desired. It is also possible to introduce the blowing agent or blowing agent mixture directly into the reaction mixture, expediently by means of a suitable mixing device.

In order to expedite the foam-forming reaction, one or more curing catalysts are included in the formulation. Preferably, both a blowing catalyst and a curing catalyst are present. While it is known that some catalysts may promote both blowing and curing (so-called “balanced” catalysts), they are conventionally differentiated by their tendency to favor either the urea-forming (blowing) reaction (in the case of the blowing catalyst), or the urethane-forming (gelling) reaction (in the case of the curing catalyst). In some non-limiting embodiments, a catalyst that technically may catalyze both blowing and curing may be selected for its more-favored tendency, e.g., curing, and combined with another catalyst directed more toward the other purpose, e.g., blowing, and vice versa.

Examples of suitable blowing catalysts that tend to favor the blowing reaction are short chain tertiary amines or tertiary amines containing at least one oxygen, such as bis-(2-dimethylaminoethyl)ether; pentamethyldiethylene-triamine, triethylamine, tributyl amine, N,N-dimethylaminopropylamine, dimethylethanolamine, N,N,N′,N′-tetra-methylethylenediamine, and urea. In one embodiment, a mixture of bis(dimethylaminoethyl)ether in dipropylene glycol may be an effective blowing catalyst, for example, in a 70/30 weight percent ratio. Combinations of any of the above may also be selected.

Examples of suitable curing catalysts that tend to favor the gelling reaction, include, generally, amidines, metallic catalysts, and combinations thereof. These may include, but are not limited to, amidines such as 1,8-diazabicyclo[5.4.0]undec-7-ene and 2,3- dimethyl-3,4,5,6-tetrahydropyrimidine, and their salts.

Metallic catalysts include tin compounds, such as tin(II) salts of organic carboxylic acids such as tin(II) diacetate, tin(II) dioctanoate, tin(II) diethylhexanoate, and tin(II) dilaurate, and dialkyltin(IV) salts of organic carboxylic acids, e.g., dibutyltin diacetate, dibutyltin dilaurate, dibutyltin maleate and dioctyltin diacetate. Bismuth salts of organic carboxylic acids may also be selected, such as, for example, bismuth octanoate. The organometallic compounds may be selected for use alone or in combinations, or, in some embodiments, in combination with one or more of the amines listed hereinabove.

Example of catalysts able to promote both blowing and curing reactions are cyclic tertiary amines or long chain amines containing several nitrogens such as dimethylbenzylamine, N-methyl-, N-ethyl-, and N-cyclohexylmorpholine, N,N,N′,N′-tetramethylbutanediamine and N,N,N′,N′-tetramethylhexanediamine, bis(dimethylamino-propyl)urea, dimethylpiperazine, dimethylcyclohexylamine, 1,2-dimethyl-imidazole, 1-aza-bicyclo [3.3.0] octane and 1,4-diazabicyclo [2.2.2] octane (TEDA).

Another class of catalysts for both blowing and curing reactions are alkanolamine compounds such as triethanolamine, triisopropanolamine, N-methyl-and N-ethyldiethanolamine, and dimethylethanolamine may also be selected. Combinations of any of the above may also be effectively employed.

Examples of commercially available blowing, curing or blowing/curing catalyst include NIAX A-4, NIAX A6, POLYCAT 6, POLYCAT 5, POLYCAT 8, Niax A1; POLYCAT 58, DABCO T, DABCO NE 300, TOYOCAT RX 20, DABCO DMDEE, JEFFCAT ZR 70, DABCO™ 33 LV, NIAX A-33, DABCO R-8020, NIAX TMBDA, POLYCAT 77, POLYCAT 6, POLYCAT 9, POLYCAT 15, JEFFCAT ZR 50, TOYOCAT NP, TOYOCAT F94, DABCO NEM, etc. POLYCAT and DABCO catalysts are available from Air Products; TOYOCAT catalysts are available from Tosho Corporation; NIAX Catalysts are available from Momentive Performance Material; and JEFFCAT catalysts are available from Huntsman.

Some of these catalysts being solids or crystals can be dissolved in a solvent that can be polyol, water, blowing agent, DPG or any carrier compatible with the polyurethane foaming.

A third class of catalysts includes the isocyanate trimerization catalysts. These include, for example tris(dialkylaminoalkyl)-s-hexahydrotriazines such as 1,3,5-tris(N,N-dimethylaminopropyl)-s-hexahydrotriazine; DABCO TMR 30, DABCO K 2097; DABCO K15, potassium acetate, potassium octoate; POLYCAT 41, POLYCAT 43, POLYCAT 46, DABCO TMR, CURITHANE 352, tetraalkylammonium hydroxides such as tetramethylammonium hydroxide, alkali metal hydroxides such as sodium hydroxide, alkali metal alkoxides such as sodium methoxide and potassium isopropoxide, and alkali metal salts of long-chain fatty acids having 10 to 20 carbon atoms and, in some embodiments, pendant hydroxyl groups. While these trimerization catalysts can be added to the other blowing and curing catalysts to boost foam reactivity, these are not required for the present invention.

In one particular embodiment, the combined amount of the blowing and curing catalysts, not considering the solvents, is greater than about 1.7 percent, based on the weight of the polyol system. In some embodiments, the combined amount of blowing and curing catalysts is 2 percent or greater of the polyol system. Generally the level of blowing and curing catalyst is less than 5 percent of the polyol system. The amount of catalyst can vary based on the temperatures of the materials, and the reactivity of the starting materials.

In addition to the foregoing components, the formulation may include additional, optional components. Among these is a surfactant, or a combination of surfactants. Inclusion of a surfactant in the formulation helps to emulsify the liquid components, regulate cell size, and stabilize the cell structure to prevent collapse and sub-surface voids. Suitable surfactants include, but are not limited to, silicon-based compounds such as silicone oils and organosilicone-polyether copolymers, such as polydimethyl siloxane and polydimethylsiloxane-polyoxyalkylene block copolymers, e.g., polyether modified polydimethyl siloxane. Other suitable surfactants include silica particles and silica aerogel powders, as well as organic surfactants such as nonylphenol ethoxylates and VORASURF™ 504, which is an ethylene oxide/butylene oxide block co-polymer having a relatively high molecular weight. Many surfactant products sold under tradenames such as DABCO™ and TEGOSTAB™ may be useful in the inventive formulations.

Additional formulation components may include pigments and colorants; flame retardants; antioxidants; surface modifiers; bio-retardant agents; mold release agents; combinations thereof; and the like.

The formulation components may be combined and introduced into a mold or cavity in any way known in the art to produce a rigid polyurethane foam. In general, the polyol system component is first combined with the blowing agent, catalysts, crosslinkers and/or chain extenders, surfactant, and any additional additives to form a “B” side (in Europe, the “A” side), and this “B” side is then quickly contacted with the “A” side (in Europe, the “B” side), in order to begin the foaming and polymerization reactions. An isocyanate index of from about 70 to about 500 is frequently conveniently employed; in some non-limiting embodiments, from about 80 to about 300; in other non-limiting embodiments, from about 90 to about 150; and in still other non-limiting embodiments, from about 100 to about 130. Those skilled in the art will be aware of various types of equipment to accomplish the contact while ensuring that an adequate level of mixing occurs to ensure uniformity of the final foam. One way to do this is to use a mixing injection head, wherein the two “sides” of the formulation are combined and mixed and then, more or less simultaneously, injected into the mold or cavity to be filled. The so-called “one shot” injection, wherein the mold or cavity is filled from a single injection point while simultaneously drawing a vacuum from another point, is particularly desirable. The vacuum may facilitate mold- or cavity-filling before the formulation gels. The gel time in particular embodiments may be less than about 25 seconds, and in other embodiments may be less than about 20 seconds. In some embodiments the gel time may be less than about 15 seconds.

The reactive foam-forming system preferably exhibits a flow index of <1.20, more preferably <1.175, and even more preferably <1.160. Desirably a reduced atmospheric pressure of from about 150 to about 950 millibars (mbar) (15 to 95 kPa) absolute may be employed, and more desirably from about 400 to about 800 mbar absolute (40 to 90 kPa). (Atmospheric pressure is approximately 1013.25 mbar, or 101.325 kPa.) Art further describing application of a suitable reduced atmospheric pressure environment may be found in WO 2007/058793 A1; U.S. Pat. No. 5,972,260 A; WO 2006/013004 A1; WO 2006/013002 A1; and WO 2000/047384 A2. Where a mold is used, demolding may be carried out using standard methodologies, and where desirable, suitable external and/or internal mold release agents may be employed.

In another embodiment, the reactive foam-forming system is injected into a cavity at or above atmospheric pressure and a vacuum is then applied to the mold. In a further embodiment, the degree of vacuum may also be varied during the foaming process.

The reduced atmospheric pressure is maintained until the reactive foam-forming system has filled the cavity and formed a gel, i.e. a three-dimensional polymeric network. The reduced atmospheric pressure may be maintained until the gel has polymerized sufficiently that the foam can be demolded. Demolding is done by removing the foam from the mold and/or removing an appliance containing the foam from the jig or other apparatus that holds the appliance in place during the foaming operation.

The formulation and process of the invention may be used to produce fine-celled, rigid polyurethane foams having a density of less than about 40 kg/m³; in certain embodiments the density is less than about 38 kg/m³; and in other embodiments the density is less than about 36 kg/m³. Density is measured according to ASTM 1622-88. For pipe-in-pipe applications, the molded density will generally greater than 40 kg/m³ and may generally be in the range of 50 to 150 kg/m³. The cells may, in certain non-limiting embodiments, be at least about 70 percent closed; in other non-limiting embodiments, at least about 80 percent closed; and in still other non-limiting embodiments, at least about 85 percent closed. The foams may also, in certain non-limiting embodiments, exhibit an average cell diameter of less than about 250 microns, and in some embodiments less than about 200 microns.

A surprising and important advantage of this invention is its thermal performance at low temperatures, especially when the blowing agent is a mixture of water, a hydrocarbon and a HFO and/or HCFO. Rigid polyurethane foams made only with water certain HFO and HCFO compounds, particularly those having boiling temperatures in the range of 20° C. to 60° C., often demonstrate a drop-off in thermal conductivity at lower temperatures, if present in high concentrations in the foam cells and/or in higher water formulations. Foam containing these blowing agents often exhibit very low thermal conductivities when evaluated at higher temperatures, but when evaluated at lower temperatures more representative of refrigerator or freezer operating conditions, an increased thermal conductivity is seen. With this invention, the low temperature loss of thermal insulation capacity is avoided. This is a surprising effect, as the hydrocarbons have thermal conductivity values significantly higher than those of the HFOs and HCFOs, and their inclusion would be expected to result in a loss of thermal insulation values. Applicants have found this not to be the case, especially when the HFO is 1336mzz. In some embodiments, a thermal conductivity of less than about 18.5 mW/m-K, less than about 18.0 mW/m-K or even 17.5 mW/m-K or less at 10° C. average plate temperature are achieved. Such foams may be particularly useful for both molded and cavity-filling applications, such as in appliance insulating walls for uses such as, non-limiting embodiments, refrigerators, freezers, and hot water storage tanks.

The description hereinabove is intended to be general and is not intended to be inclusive of all possible embodiments of the invention. Similarly, the following examples are provided to be illustrative only and are not intended to define or limit the invention in any way. Those skilled in the art will be fully aware that other embodiments, within the scope of the claims, will be apparent, from consideration of the specification and/or practice of the invention as disclosed herein.

### EXAMPLES 1-3 AND REFERENCE FOAM A

Foam Example 1 and Reference Foams A and B are made using the formulation set forth in Table 1.

TABLE 1

| Ingredient | Parts by Weight |
|---|---|
| Propoxylated toluene diamine, 440 OH number | 40 |
| Aromatic polyester polyol, 2.0 functionality, 314 OH | 15 |
| number | |
| Propoxylated sorbitol, OH number 480 | 25 |
| Propoxylated glycerin, 156 OH number | 9.2-9.5 |
| Glycerin | 2.5 |
| Silicone surfactant | 3.0 |
| N,N,N′,N′,N′-pentamethyldiethylenetriamine catalyst | 1.8-2.1 |
| (Polycat ™ 5 from Air Products and Chemicals) | |
| Dimethylcyclohexylamine catalyst (Polycat ™ 8 | 1.0 |
| from Air Products and Chemicals) | |
| Trimerization catalyst (Dabco ™ K 2097 from Air | 0.1 |
| Products and Chemicals) | |
| Trimerization Catalyst (Dabco ™ TMR 30 from Air | 0.7 |
| Products and Chemicals) | |
| Polymeric MDI, 31% NCO content | 136 |
| Blowing agent | (per Table 2 |
| | below) |

The foregoing components are processed on a high pressure Cannon machine equipped with a mix-head attached to a mold injection hole, in a laboratory where the atmospheric pressure is about 100 kPa. This mold/mixhead connection is air-tight. The polyol system and additional formulation components are premixed and then injected, simultaneously with the isocyanate component, into a Brett mold at a mix-head pressure of at least 90 mbar. The temperature of the components is kept at 20° C. +/−2° C. The output of the machine is 150 to about 250 grams per second. The Brett mold is made of aluminum with dimensions of 200×20×5 cm and has no venting, which allows the creation of a reduced atmospheric pressure in the mold during foaming. The internal pressure of the mold is controlled via a pipe connected to a 500 liter buffer tank that is connected to a medium capacity vacuum pump (1500 L/min). The vacuum in the buffer tank, and thus the in-mold air pressure, is maintained with control valves. The temperature of the mold is about 45° C. and the internal mold pressure is 0.7 bar (about 70 kPa). Typical demold-time of the foams is in the range of from about 8 to about 10 minutes. A release agent is applied to the mold prior to filling in order to facilitate demolding.

Foam samples are cut from the core of the molded part 24 hours after foam production and these samples are used for testing immediately after cutting. Lambda, i.e., thermal conductivity, is measured at 10° C. average plate temperature according to ISO 12939-01/ DIN 52612, using a Lasercomp FOX 200. The blowing agent composition and results of the thermal conductivity testing are as set forth in Table 2. Molded foam density is measured according to ASTM 1622-88. Foam compressive strength in kPa is measured according to DIN 53421-06-84. Values reported are an average of five (5) samples taken from various positions of the Brett mold.

Free rise density is measured on a 100×100×100 mm foam block obtained from the center of a free-rising foam (at ambient air pressure) produced foaming at least 250 grams of the foam formulation.

Gel time is determined on free-rise foams made in an open 20×20×20 cm mold at ambient pressure, with a shot-weight of at least 250 grams. Gel time is the time in seconds from the beginning of the mixing process until a string can be pulled from the rising foam using a tongue depressor.

Minimum fill density is measured by forming the foam formulation and immediately injecting it into the Brett mold, which is oriented vertically (i.e., 200 cm direction oriented vertically) and preheated to 45±5° C. The composition is permitted to expand against its own weight and cure inside the mold. The amount of polyurethane-forming composition is selected such that the resulting foam fills at least 95% of the mold. The minimum fill density is determined from the weight of the foam formulation, extrapolated if the Brett mold is not completely filled. The flow index is calculated taking the ratio of the MFD over the FRD.

TABLE 2

| | Reference A | Example 1 | Example 2 | Example 3 |
|---|---|---|---|---|
| Blowing agent | | | | |
| composition | | | | |
| Water, moles | 0.078 | 0.078 | 0.072 | 0.078 |
| (mole-%) | (27.5%) | (27.5%) | (27.1%) | (27.5%) |
| 1,1,1,4,4,4- | 0.0 | 0.134 | 0.109 | 0.205 |
| hexafluorobut-2-ene, | (0%) | (47.3%) | (39.8%) | (72.5%) |
| moles (mole-%) | | | | |
| cyclopentane, moles | 0.205 | 0.071 | 0.085 | 0 (%) |
| (mole-%) | (72.5%) | (25.1) | (31.9%) | |
| Mole ratio, | 100:0 | 35:65 | 45:55 | 0:100 |
| cyclopentane:1, | | | | |
| 1,1,4,4,4- | | | | |
| hexafluorobut-2-ene | | | | |
| Properties | | | | |
| Lambda, 10° C., | 18.5 | 17.6 | 17.5 | 17.9 |
| mW/m-K | | | | |
| Molded foam density, | 35.0 | 35.0 | 35.0 | 35.0 |
| g/cc | | | | |
| Compressive Strength, | 127 | 129 | 151 | 124 |
| kPa | | | | |
| Gel time, s | 18 | 14 | 15 | 16 |
| Free rise density, g/cc | 21.4 | 23.9 | 25.3 | 24.8 |
| Minimum fill density | 26.2 | 26.4 | 29.4 | 25.5 |
| at 70 kPa mold | | | | |
| pressure, kg/m³ | | | | |
| Flow index | 1.224 | 1.146 | 1.162 | 1.097 |

As can be seen from the data in Table 2, Examples 1 and 2, which contain a mixture of 1,1,1,4,4,4-hexafluorobut-2-ene and cyclopentane, unexpectedly have a lower lambda value than Reference 1. Compressive strength is also slightly higher for Example 1 and significantly higher for Example 2, at an equivalent foam density, compared to Reference A. Flow index for Examples 1 and 2 are significantly lower than that of Reference A. Example 3 exhibits a lower lambda value than Reference A, and significantly better flow. At these relatively high water levels, the mixture of 1,1,1,4,4,4-hexafluorobut-2-ene and cyclopentane in Examples 1 and 2 provides a greater reduction in lambda value than the use of 1,1,1,4,4,4-hexafluorobut-2-ene by itself in Example 3.

### EXAMPLES 4 AND 5 AND REFERENCE B

Foam Examples 4 and 5 and Reference Foam B are made and in the general manner described above, using the formulation set forth in Table 3. Results are set forth in Table 4.

TABLE 3

| Ingredient | Parts by Weight |
|---|---|
| Propoxylated toluene diamine, 440 OH number | 40 |
| Aromatic polyester polyol, 2.0 functionality, 315 OH | 15 |
| number | |
| Propoxylated sorbitol, OH number 480 | 25 |
| Propoxylated glycerin, 156 OH number | 8.2-8.6 |
| Glycerin | 3.3-3.8 |
| Silicone surfactant | 3.0 |
| N,N,N′,N′,N′-pentamethyldiethylenetriamine catalyst | 2.1 |
| (Polycat ™ 5 from Air Products and Chemicals) | |
| Dimethylcyclohexylamine catalyst (Polycat ™ 8 | 1.3-1.5 |
| from Air Products and Chemicals) | |
| Trimerization catalyst (Dabco ™ K 2097 from Air | 0.1 |
| Products and Chemicals) | |
| Trimerization Catalyst (Dabco ™ TMR 30 from Air | 0.7 |
| Products and Chemicals) | |
| Polymeric MDI, 31% NCO content | 132 |

TABLE 4

| | Example 4 | Example 5 | Reference B |
|---|---|---|---|
| Blowing agent composition | | | |
| Water, moles (mole-%) | 0.044 | 0.044 | 0.044 |
| | (15.7%) | (15.4%) | (14.0%) |
| 1,1,1,4,4,4-hexafluorobut-2-ene, | 0.237 | 0.170 | 0 |
| moles (mole-%) | (84.3%) | (59.6%) | (0%) |
| cyclopentane, moles (mole-%) | 0.0 | 0.071 | 0.271 |
| | (0%) | (28.5%) | (86.0%) |
| Mole ratio, cyclopentane:1, | 0:100 | 29:71 | 100:0 |
| 1,1,4,4,4-hexafluorobut-2-ene | | | |
| Properties | | | |
| Gel-time, s | 17 | 17 | 19 |
| Free Rise Density, kg/m³ | 24.9 | 24.9 | 22.2 |
| Lambda, 10° C., mW/m-K | 17.6 | 17.5 | 18.1 |
| Molded foam density, g/cc | 35.1 | 35.2 | 35.1 |
| Compressive Strength, kPa | 133 | 137 | 139 |
| Closed cells (%) | 94.9 | 94.8 | 95.1 |
| Minimum fill density at 70 kPa | 28.0 | 28.2 | 26.5 |
| mold pressure, kg/m³ | | | |
| Flow index | 1.124 | 1.133 | 1.194 |

Examples 4 and 5 both exhibit significantly lower lambda values and lower flow indices than Reference B. The density of Example 4 and 5 are slightly higher than Reference B, but this is due to the use of about 10% less blowing agent in Examples 4 and 5. In this set of examples, with a lower proportion of water in the blowing agent mixture, the mixture of the hydrocarbon and HFO results in a small improvement in lambda, compared to the HFO by itself.

### EXAMPLES 6-9

Foam Examples 6-9 are made and in the general manner described above, using the formulation set forth in Table 5. Results are set forth in Table 6.

TABLE 5

| Ingredient | Parts by Weight |
|---|---|
| Propoxylated toluene diamine, 440 OH number | 40 |
| Aromatic polyester polyol, 2.0 functionality, 315 OH | 15 |
| number | |
| Propoxylated sorbitol, OH number 480 | 25 |
| Propoxylated glycerin, 156 OH number | 7.5-8.1 |
| Glycerin | 4.0-4.7 |
| Silicone surfactant | 3.0 |
| N,N,N′,N′,N′-pentamethyldiethylenetriamine catalyst | 2.1 |
| (Polycat ™ 5 from Air Products and Chemicals) | |
| Dimethylcyclohexylamine catalyst (Polycat ™ 8 | 1.3-1.5 |
| from Air Products and Chemicals) | |
| Trimerization catalyst (Dabco ™ K 2097 from Air | 0.1 |
| Products and Chemicals) | |
| Trimerization Catalyst (Dabco ™ TMR 30 from Air | 0.7 |
| Products and Chemicals) | |
| Polymeric MDI, 31% NCO content | 132 |

TABLE 6

| | Example 6 | Example 7 | Example 8 | Example 9 |
|---|---|---|---|---|
| Blowing agent | | | | |
| composition | | | | |
| Water, moles (mole-%) | 0.025 | 0.027 | 0.027 | 0.027 |
| | (8.9%) | (9.1%) | (9.0%) | (8.8%) |
| 1,1,1,4,4,4- | 0.256 | 0.195 | 0.158 | 0.121 |
| hexafluorobut-2-ene, | (91.1%) | (65.9%) | (52.8%) | (39.7%) |
| moles (mole-%) | | | | |
| cyclopentane, moles | 0.0 (%) | 0.074 | 0.114 | 0.157 |
| (mole-%) | | (25.0%) | (38.1%) | (51.5%) |
| Mole ratio, | 0:100 | 28:72 | 42:58 | 56:44 |
| cyclopentane:1,1,1,4,4,4- | | | | |
| hexafluorobut-2-ene | | | | |
| Properties | | | | |
| Gel-time, s | 18 | 18 | 17 | 18 |
| Free rise density, kg/m³ | 26.5 | 24.6 | 23.8 | 23.5 |
| Lambda, 10° C., | 17.4-17.8 | 17.3-17.4 | 17.3-17.6 | 17.4-17.6 |
| mW/m-K | | | | |
| Molded foam density, | 35 | 35 | 35 | 34.9 |
| g/cc | | | | |
| Compressive Strength, | 137 | 144 | 139 | 136 |
| kPa | | | | |
| Closed cells (%) | 93.4 | 95.2 | 94.6 | 94.5 |
| Minimum fill density at | 28.2 | 27.7 | 27.5 | 28.1 |
| 70 kPa mold pressure, | | | | |
| kg/m³ | | | | |
| Flow Index | 1.064 | 1.126 | 1.155 | 1.196 |

Foam densities decrease across this set of Examples with increasing total moles of blowing agent. Even at the low water contents in these Examples, good lambda values are obtained, with the best lambda values being shown by Examples 7 and 8, which are made with the mixture of 1,1,1,4,4,4-hexafluorobut-2-ene and cyclopentane. As shown especially by Example 9, flow index increases with increasing levels of cyclopentane.

### EXAMPLES 10 AND 11

Foam Examples 10 and 11 are made and in the general manner described above, using the formulation set forth in Table 7. Results are set forth in Table 8.

TABLE 7

| Ingredient | Parts by Weight |
|---|---|
| Propoxylated toluene diamine, 440 OH number | 40 |
| Aromatic polyester polyol, 2.0 functionality, 315 OH | 15 |
| number | |
| Propoxylated sorbitol, OH number 480 | 25 |
| Propoxylated glycerin, 156 OH number | 7.5-8.1 |
| Glycerin | 4.0-4.7 |
| Silicone surfactant | 3.0 |
| N,N,N′,N′,N′-pentamethyldiethylenetriamine catalyst | 2.1 |
| (Polycat ™ 5 from Air Products and Chemicals) | |
| Dimethylcyclohexylamine catalyst (Polycat ™ 8 | 1.3-1.5 |
| from Air Products and Chemicals) | |
| Trimerization catalyst (Dabco ™ K 2097 from Air | 0.1 |
| Products and Chemicals) | |
| Trimerization Catalyst (Dabco ™ TMR 30 from Air | 0.7 |
| Products and Chemicals) | |
| Polymeric MDI, 31% NCO content | 132 |

TABLE 8

| | Example 10 | Example 11 |
|---|---|---|
| Blowing agent composition | | |
| Water, moles (mole-%) | 0.0278 (9.3%) | 0.0278 (9.5) |
| 1-chloro-3,3,3-trifluoropropene, | 0.269 (90.7%) | 0.195 (66.4) |
| moles (mole-%) | | |
| cyclopentane, moles (mole-%) | 0.0 (0%) | 0.071 (24.1) |
| Mole ratio, cyclopentane:1-chloro- | 0:100 | 27:73 |
| 3,3,3-trifluoropropene | | |
| Properties | | |
| Gel-time, s | 18 | 19 |
| Free rise density, kg/m³ | 22.5 | 23.1 |
| Lambda, 10° C., mW/m-K | 16.2-16.2 | 16.7-16.9 |
| Molded foam density, g/cc | 35 | 35.1 |
| Compressive Strength, kPa | 126 | 149 |
| Closed cells (%) | 95.1 | 95.1 |

Examples 10 and 11 exhibit very low lambda values. Unlike the case in the previous examples, replacement of a portion of 1-chloro-3,3,3-trifluoropropene with cyclopentane does not lead to a reduction of lambda, as the lambda value of Example 11 is somewhat higher than that of Example 10.

1. A process for preparing a cavity-filling closed cell rigid polyurethane foam comprising (a) preparing a reactive foam-forming system comprising as components at least one organic polyisocyanate; a polyol mixture having an average functionality of at least 3.0 hydroxyl groups per molecule and an average hydroxyl equivalent weight of 75 to 250; a blowing agent mixture containing water, at least one HFO or HCFO and optionally at least one hydrocarbon, the blowing agent mixture containing 5 to 60 mole percent water and at least 2 mole percent of the HFO or HCFO; (b) injecting the reactive foam-forming system into a cavity and expanding the foam-forming system under reduced atmospheric pressure (c) maintaining the reduced atmospheric pressure at least until a gel forms and further curing the reactive foam-forming system to produce a closed cell rigid polyurethane foam having a density of less than about 40 kg/m³ and a thermal conductivity of less than 19 mW/m·K at 10° C. average plate temperature, according to ISO 12939/DIN 52612.

2. A process for preparing a cavity-filling closed cell rigid polyurethane foam comprising (a) preparing a reactive foam-forming system comprising as components at least one organic polyisocyanate; a polyol mixture having an average functionality of at least 3.0 hydroxyl groups per molecule and an average hydroxyl equivalent weight of 75 to 250; a blowing agent mixture containing water, a hydrocarbon blowing agent and at least one HFO or HCFO, the blowing agent mixture containing 5 to 60 mole percent water and the mole ratio of the hydrocarbon and the HFO or HCFO being 5:95 to 95:5; (b) injecting the reactive foam-forming system under a reduced atmospheric pressure into a cavity and expanding the foam-forming system under reduced atmospheric pressure (c) maintaining the reduced atmospheric pressure at least until a gel forms and further curing the reactive foam-forming system to produce a closed cell rigid polyurethane foam having a density of less than about 40 kg/m³ and a thermal conductivity of less than 19 mW/m·K at 10° C. average plate temperature, according to ISO 12939/DIN 52612.

3. The process of claim 2 wherein the blowing agent mixture contains 20 to 60 mole percent water.

4. The process of claim 3 wherein the blowing agent mixture contains 20 to 33 mole percent water.

5. The process of claim 4 wherein the blowing agent mixture contains 22 to 30 mole percent water.

6. The process of claim 2 wherein the mole ratio of hydrocarbon blowing agent to HFO and HFCO is 15:85 to 50:50.

7. The process of claim 2 wherein the mole ratio of hydrocarbon blowing agent to HFO and/or HFCO is 30:70 to 50:50.

8. The process of claim 2 wherein the mole ratio of hydrocarbon blowing agent to HFO and HFCO is 15:85 to 30:70.

9. The process of claim 6 wherein the hydrocarbon includes cyclopentane.

10. The process of of claim 2 wherein the HFO or HCFO is one or more of HFO 1234ze (1,3,3,3-tetrafluoropropene), HCFO 1233zd (1-chloro-3,3,3-trifluoropropene), HFO 1336 mzz (1,1,1,4,4,4-hexafluorobut-2-ene).

11. The process of of claim 2 wherein the HFO or HCFO is HFO 1336 mzz (1,1,1,4,4,4-hexafluorobut-2-ene).

12. The process of claim 2 wherein the blowing agent contains no more than 2 mole percent of another blowing agent.

13. The process of of claim 2 wherein the reduced atmospheric pressure is 35 to 95 kPa absolute.

14. The process of of claim 2 wherein the reduced atmospheric pressure is 40 to 90 kPa absolute.

15. The process of of claim 2 wherein the foam has a lambda value of 17.5 mW/m-K or less and a flow index of <1.175.
